(19) United States
(12) Patent Application Publication
(10) Pub. No.: US 2014/0052793 A1
(43) Pub. Date: Feb. 20, 2014

(54) MESSAGE SYNCHRONIZATION WITH EXTENDED PROPERTIES

(71) Applicants: Aby John, San Francisco, CA (US); Reema Sardana, Sunnyvale, CA (US)

(72) Inventors: Aby John, San Francisco, CA (US); Reema Sardana, Sunnyvale, CA (US)

(73) Assignee: Microsoft Corporation, Redmond, WA (US)

(21) Appl. No.: 13/586,159

(22) Filed: Aug. 15, 2012

(51) Int. Cl. G06F 15/16

(52) U.S. Cl. 709/206

(57) ABSTRACT

Among other things, one or more techniques and/or systems are provided for synchronizing a text message, such as an MMS message and/or an SMS message, in full fidelity between a computing device and a message synchronization service. That is, content, natively supported by message synchronization protocols, and extended properties, not natively supported by message synchronization protocols, of a text message may be synchronized between a computing device and a message synchronization service. In particular, a message synchronization protocol may be modified to support annotations and/or extended headers, within which one or more extended properties may be specified. In this way, a synchronization message may comprise natively supported content and/or an extended property specified within an annotation and/or an extended header within the synchronization message. The synchronization message may be communicated between the computing device, the message synchronization service, and/or an email service for synchronization of the text message.

### BACKGROUND

Today, computing devices, such as personal computers, mobile phones, tablet devices, etc., allow users to communicate over a variety of communication mediums. For example, users may communicate over an IP phone connection, email, and/or text messaging, such as short message service (SMS) text messages, multimedia message service (MMS) text messages, social network message, etc. An email server may be configured to manage email communication functionality, such as sending of email messages, delivery of email messages, email backup functionality, email restoration functionality, etc. Unfortunately, conventional message synchronization services for text messaging may not provide robust text messaging functionality. For example, a message synchronization service may not provide synchronization functionality of text messages in full fidelity. In one example, when a mobile phone synchronizes a text message with the message synchronization service for storage as a synchronized text message, various extended properties of the text message (e.g., a subject property, read or unread property, a delivery property, a sent property, etc.) may be lost because a message synchronization protocol, such as the Exchange ActiveSync protocol, used during synchronization may not support communication of such extended properties. In this way, when a user restores the synchronized text message, such as on a new mobile phone, the restored text message may be missing the extended properties that were lost during synchronization.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for synchronizing a text message, such as a short message service (SMS) message and/or a multimedia message service (MMS) message, between a computing device and a message synchronization service are provided herein. It may be appreciated that while SMS messages and/or MMS messages are referred to herein, that an SMS message may comprise an MMS message and that an MMS message may comprise an SMS message. That is, the one or more systems and/or techniques provided herein are applicable to both MMS and SMS.

In an example of synchronizing a text message, a synchronize-to-service message may be generated, for example by a computing device such as a mobile phone or tablet device. The synchronize-to-service message may comprise SMS content associated with an SMS message. For example, the SMS content may comprise message text “Want to meet for lunch later?”, a “to” field “Dave 555-555-1234”, a “from” field “Steve 555-555-8709”, and/or other properties natively supported by a message synchronization protocol.

It may be appreciated that in one example, the message synchronization protocol may be modified to support annotations, an extended header (e.g., an extended header of a message body, such as an SMS message body), and/or MMS messages. Accordingly, an extended property may be stored within an annotation and/or an extended header within the synchronize-to-service message. In one example, an extended property may comprise a property that is not natively supported by the message synchronization protocol, such as a delivery property (e.g., a delivery time), a sent property (e.g., a sending time), a subject property, a message status property (e.g., whether the message was an in-bound message to the computing device or an out-bound message from the computing device; whether the message has been read or is unread; etc.), etc. Because the extended property may not be natively supported by the message synchronization protocol, the extended property may be passed within the annotation and/or the extended header, which may be supported by the modified message synchronization protocol. The synchronize-to-service message, comprising the SMS content and the extended property, may be sent to the message synchronization service for storage of the SMS message as a synchronized SMS message comprising the extended property. In this way, the synchronized SMS message may retain the extended property of the SMS message. Thus, if the synchronized SMS message is used to create a restored SMS message on a computing device (e.g., a different or new cell phone), then the restored SMS message may comprise the extended property in addition to SMS content. It may be appreciated that an MMS message may be similarly synchronized between the computing device and the message synchronization service using a synchronize-to-service message.

In an example of synchronizing a text message, a synchronize-to-device message may be received by the computing device from the message synchronization service. The synchronize-to-device message may comprise SMS content associated with a synchronized SMS message stored by the message synchronization service (e.g., a synchronized SMS message that was uploaded from the computing device or from a different computing device). The synchronize-to-device message may comprise an extended property, such as a delivery property, a sent property, a subject property, a message status property, and/or other properties that may not be natively supported by the message synchronization protocol. Accordingly, the message synchronization protocol may be modified to support annotations and/or extended headers, through which extended properties may be passed between the message synchronization service and the computing device. In one example, the synchronize-to-device message may comprise an annotation within which the extended property may be stored. In another example, the synchronize-to-device message may comprise an extended header (e.g., comprised within a text message body, such as an SMS message body) within which the extended property may be stored. In this way, the computing device may receive the synchronize-to-device message comprising the SMS content and/or the extended property associated with the synchronized SMS message.

The synchronized SMS message may be restored using the SMS content and/or the extended property to create a restored SMS message. The restored SMS message may comprise a full fidelity version of the synchronized SMS because the restored SMS message may comprise the extended property as well as the SMS content. The restored SMS may be available for use by a local SMS messaging application hosted by the computing device. In this way, the computing device may restore one or more SMS messages, in full fidelity, that were previously synchronized from the computing device and/or other computing devices to the message synchronization service. It may be appreciated that an MMS message may be similarly synchronized between the message synchronization service and the computing device using a synchronize-to-device message.

The following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of synchronizing a text message, such as an SMS message and/or an MMS message, between a computing device and a message synchronization service.

FIG. 2 is a flow diagram illustrating an exemplary method of synchronizing a text message, such as an SMS message and/or an MMS message, between a computing device and a message synchronization service.

FIG. 3 is a component block diagram illustrating an exemplary system for synchronizing a text message, such as an SMS message and/or an MMS message, between a computing device and a message synchronization service.

FIG. 4 is a component block diagram illustrating an exemplary system for synchronizing a text message, such as an SMS message and/or an MMS message, between a computing device and a message synchronization service.

FIG. 5 is a component block diagram illustrating an exemplary system for synchronizing a text message, such as an SMS message and/or an MMS message, between an email service and a message synchronization service.

FIG. 6 is an illustration of an example of a synchronize message.

FIG. 7 is an illustration of an exemplary computer-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many users communicate through text messaging, such as SMS messaging and/or MMS messaging. For example, a first user may send, from a tablet device, an MMS message comprising message text and an image to a second user. The second user may receive, on a mobile phone, the MMS message, which may be stored on the mobile phone. Unfortunately, if the mobile phone of the second user is lost or damaged, then the second user may not have access to the MMS message that was saved on the mobile phone. Thus, when the user obtains a new mobile phone, the user may not have access to the MMS message that was saved on the lost or damaged mobile phone.

Accordingly, a message synchronization service may allow a user to upload text messages as synchronized text messages and/or download synchronized text messages. In this way, a synchronized text message may be available through the message synchronization service regardless of whether a computing device comprising an original text message is available. Unfortunately, conventional synchronization protocols utilized by the message synchronization service may not provide a mechanism for a text message to be synchronized in full fidelity because merely SMS content, such as message text, a “to” field, a “from” field, etc., may be natively supported by a conventional message synchronization protocol used to communicate synchronized messages between a computing device and the message synchronization service. In particular, extended properties, such as a delivery property, a sent property, a subject property, a message status property, etc., may not be natively supported by the conventional message synchronization protocol. Thus, when a user uploads an SMS message to the message synchronization service merely SMS content is uploaded, while extended properties are not uploaded because the conventional message synchronization protocol does not support a mechanism for describing such extended properties. Similarly, the conventional synchronization protocol may not support synchronization of MMS messages.

Accordingly, one or more systems and/or techniques for synchronizing a text message in full fidelity, including extended properties, between a computing device and a message synchronization service are provided herein. In one example, a message synchronization protocol, such as an Exchange ActiveSync protocol, may be modified to support annotations and/or extended headers through which extended properties may be passed between the computing device and the message synchronization service for synchronization of text messages in full fidelity. In another example, the message synchronization protocol may be modified to support uploading, downloading, and/or synchronizing of MMS messages (e.g., by utilizing one or more extended properties relating to MMS messages).

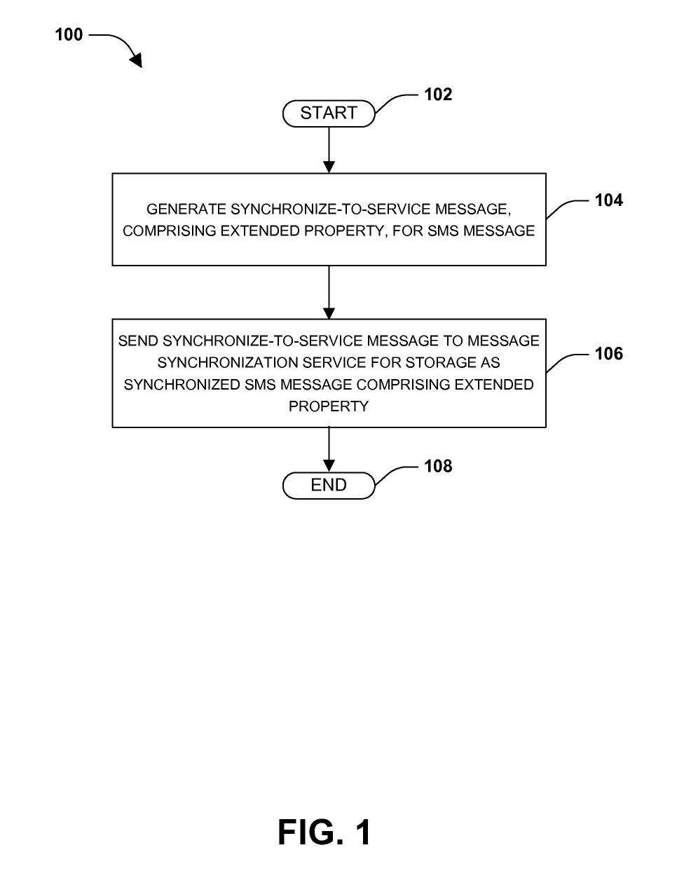

One embodiment of synchronizing a text message, such as an SMS message and/or an MMS message, between a computing device and a message synchronization service is illustrated by an exemplary method 100 in FIG. 1. At 102, the method starts. It may be appreciated that while method 100 is described with relation to an SMS message, that method 100 may also apply to an MMS message. At 104, a synchronize-to-service message may be generated. For example, the synchronize-to-service message may be generated responsive a user of the computing device, such as a mobile phone, initializing an upload to cloud command for synchronization of an SMS message from the computing device to the message synchronization service.

The synchronize-to-service message may comprise SMS content associated with the SMS message. For example, the SMS content may comprise message text (e.g., the SMS message comprises “Hey Stu, this is Pete . . . want to meet for dinner tonight with Joe?”), a “to” field (e.g., the SMS message is sent to a phone number associated with Stu), a “from” field (e.g., the SMS message was received from a phone number associated with Pete), and/or other properties natively supported by a message synchronization protocol utilized by the message synchronization service.

Because the SMS message may comprise extended properties that may not be natively supported by the message synchronization protocol, the message synchronization protocol may be modified to support annotations and/or extended headers. In one example, the message synchronization protocol, as modified, may support an extended property that is defined according to an XML annotation format, such as:

```
<MS:Annotations>
    <MS:Annotation>
      <Name>SentTime</Name>
      <Value>2009-01-08T00:14:36.000Z</Value>
    </MS:Annotation>
</MS:Annotations>
```

In another example, the message synchronization protocol, as modified, may support an extended header that is associated with an SMS message body. For example, one or more extended properties may be defined within the extended header for the SMS message body, such that the SMS message body comprising the extended header may be passed from the computing device to the message synchronization service using the synchronize-to-service message. In this way, one or more extended properties of the SMS message (e.g., a subject property, a delivery property, a sent property, a message status property, etc.) may be stored within annotations and/or an extended header within the synchronize-to-service message.

At 106, the synchronize-to-service message may be sent to the message synchronization service for storage of the SMS message as a synchronized SMS message comprising the extended property. In this way, the SMS message is synchronized in full fidelity, such that the synchronized SMS message may be downloaded to any computing device and/or provided through an email service while preserving the extend property. For example, the computing device may receive a synchronize-to-device message from the message synchronization service. The synchronize-to-device message may comprise SMS content associated with a synchronized SMS message stored by the message synchronization service (e.g., corresponding to an original SMS message uploaded from the computing device or from a different computing device). The synchronize-to-device message may comprise an extended property of the synchronized SMS message. The extended property may be stored within an annotation and/or an extended header within the synchronize-to-device message. In this way, the computing device may restore the synchronized SMS message as a restored SMS message, comprising the extended header, for use by a local SMS messaging application. At 108, the method ends.

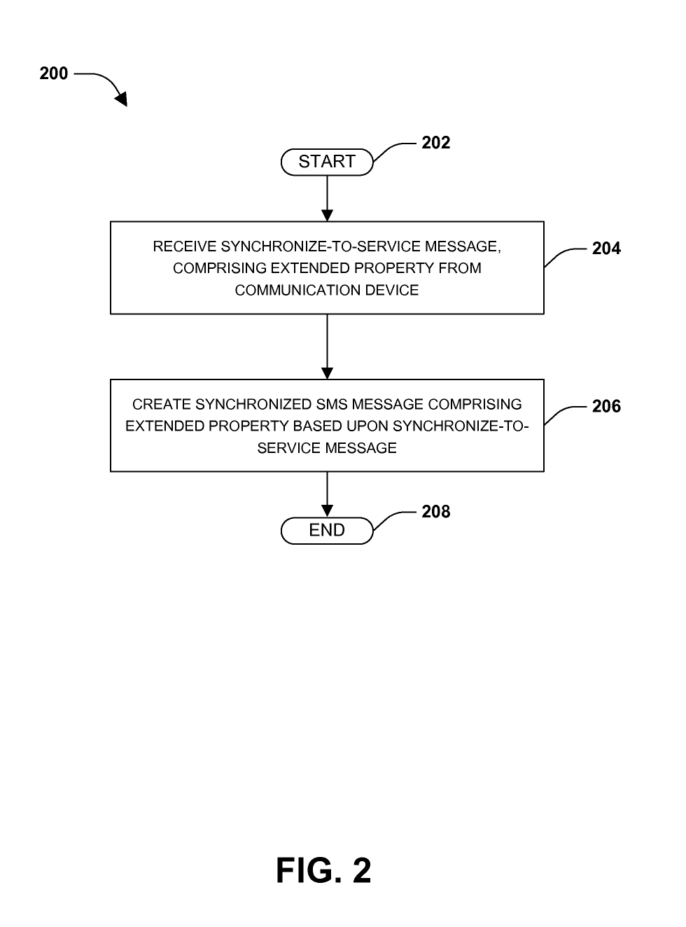

One embodiment of synchronizing a text message, such as an SMS message and/or an MMS message, between a computing device and a message synchronization service is illustrated by an exemplary method 200 in FIG. 2. At 202, the method starts. It may be appreciated that while method 200 is described with relation to an SMS message, that method 200 may also apply to an MMS message. At 204, a synchronize-to-service message is received from a computing device at a message synchronization service (e.g., a cloud-based message synchronization service hosted by one or more cloud computing servers). The synchronize-to-service message may comprise SMS content associated with an SMS message stored on the computing device. The synchronize-to-service message may comprise an extended property stored within an annotation and/or an extended header within the synchronize-to-service message. That is, because a message synchronization protocol utilized by the message synchronization service may not natively support the extended property, the extended property may be stored within the annotation and/or the extended header, which may be supported by a modification to the message synchronization protocol. In this way, the message synchronization service may receive the synchronize-to-service message comprising one or more extended properties of the SMS message (e.g., a delivery property, a delivery time, a sent property, a sending time, a subject property, and/or a message status property, such as whether the SMS message was sent to the computing device or sent from the computing device and/or whether the SMS message is read or unread) as well as SMS content for synchronization.

At 206, a synchronized SMS message is created based upon the synchronize-to-service message. For example, the synchronized SMS message may comprise the SMS content and/or the extended property from the synchronize-to-service message. In this way, the synchronized SMS message corresponds to a full fidelity version of the SMS message, such that the synchronized SMS message may be restored on any computing device and/or provided through an email service, while retaining the extended property.

In one example, a download command for the synchronized SMS message may be received from the computing device. For example, a user of the computing device may issue the download command to restore the synchronized SMS message after accidently deleting the SMS message from the computing device. Accordingly, a synchronize-to-device message comprising SMS content and/or an extended property associated with the synchronized SMS message may be created by the message synchronization service, where the extended property is stored within an annotation and/or an extended header within the synchronize-to-device message. In this way, the synchronize-to-device message may be sent to the computing device for restoration of the synchronized SMS message as a restored SMS message comprising the extended property.

In another example, a download command for the synchronized SMS message may be received from a second computing device different than the computing device that synchronized the SMS message to the message synchronization service as the synchronized SMS message. For example, the user of the computing device may have obtained a new tablet device as the second computing device, and may desire to synchronize messages to the new tablet device. Accordingly, a synchronize-to-device message comprising SMS content and/or an extended property associated with the synchronized SMS message may be created by the message synchronization service, where the extended property is stored within an annotation and/or an extended header within the synchronize-to-device message. In this way, the synchronize-to-device message may be sent to the second computing device, such that the second computing device may store a copy of the synchronized SMS message comprising the extended property.

In another example, a download command for the synchronized SMS message may be received from an email service. For example, a user of the email service may request to view the synchronized SMS message through an email message box provided by the email service. Accordingly, a synchronize-to-email message comprising SMS content and/or an extended property associated with the synchronized SMS message may be created by the message synchronization service, where the extended property is stored within an annotation and/or an extended header within the synchronize-to-email message. In this way, the synchronize-to-email message may be sent to the email service, such that the email service may display the synchronized SMS message within the email message box of an email application hosted by the email service, for example. At 210, the method ends

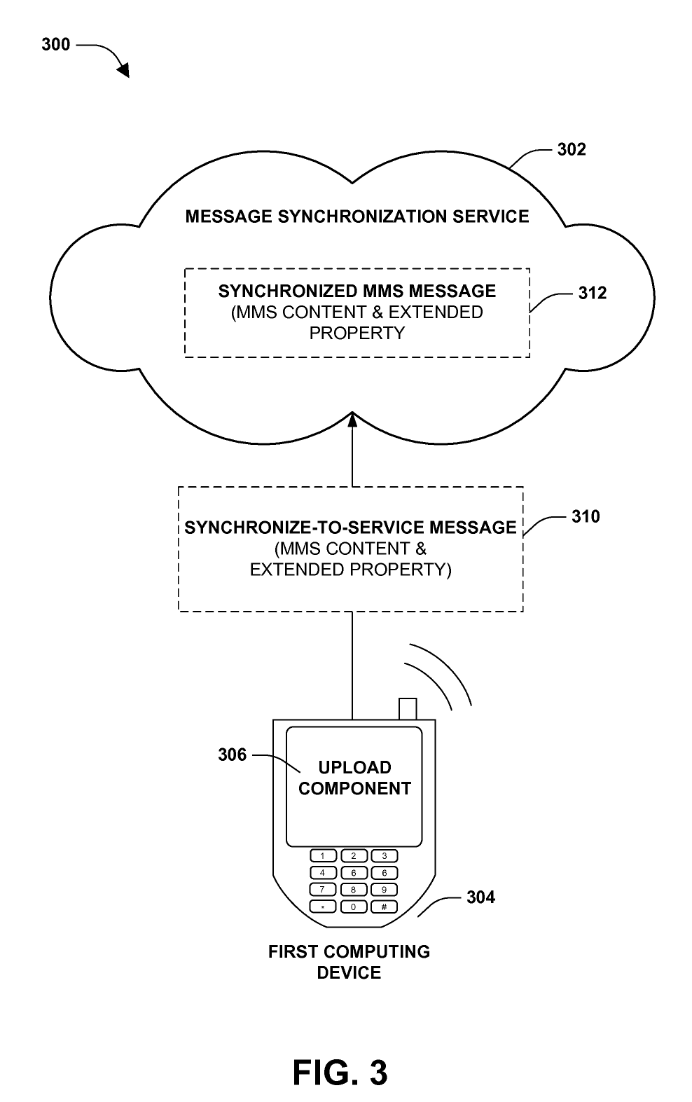

FIG. 3 illustrates an example of a system 300 configured for synchronizing a text message, such as an SMS message and/or an MMS message, between a computing device and a message synchronization service 302. It may be appreciated that while system 300 is described with relation to an MMS message, that system 300 may also apply to an SMS message. The system 300 may comprise an upload component 306. For example, the upload component 306 may be hosted by a first computing device 304. The upload component 306 may be configured to generate a synchronize-to-service message 310. For example, a user may initiate a request to upload an MMS message from the first computing device 304 to the message synchronization service 302. Responsive to the request, the upload component 306 may generate the synchronize-to-service message 310 based upon the MMS message.

In one example of generating the synchronize-to-service message 310, the upload component 306 may store MMS content (e.g., message text, a “to” property, a “from” property, and/or multimedia content, such as an image attachment, an audio attachment, etc.) associated with the MMS message within the synchronize-to-service message 310. Because a message synchronization protocol used by the message synchronization service 302, such as an Exchange ActiveSync protocol, may not support MMS messages and/or an extended property of the MMS message, the extended property may be stored as an annotation, a schema header, and/or an extended header within the synchronize-to-service message 310. That is, the message synchronization protocol may be modified to support annotations, schema headers, and/or extended headers, such that extended properties not natively supported by the message synchronization protocol may nevertheless be communicated. For example, an MMS message class and/or an MMS message type may be added to the message synchronization protocol.

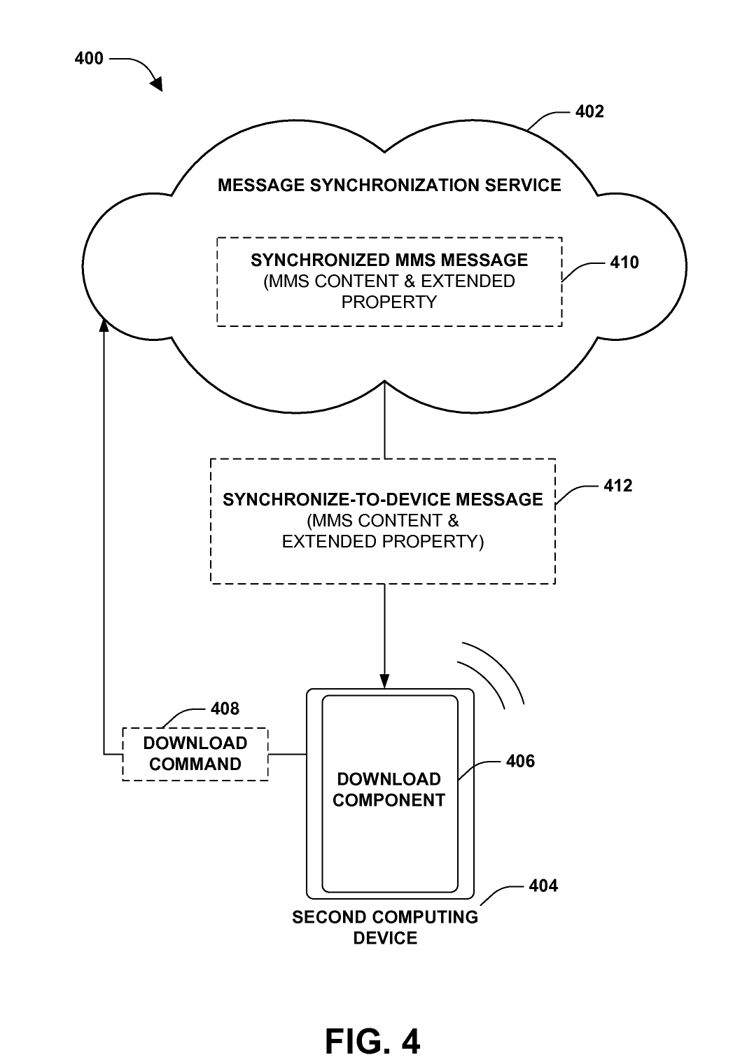

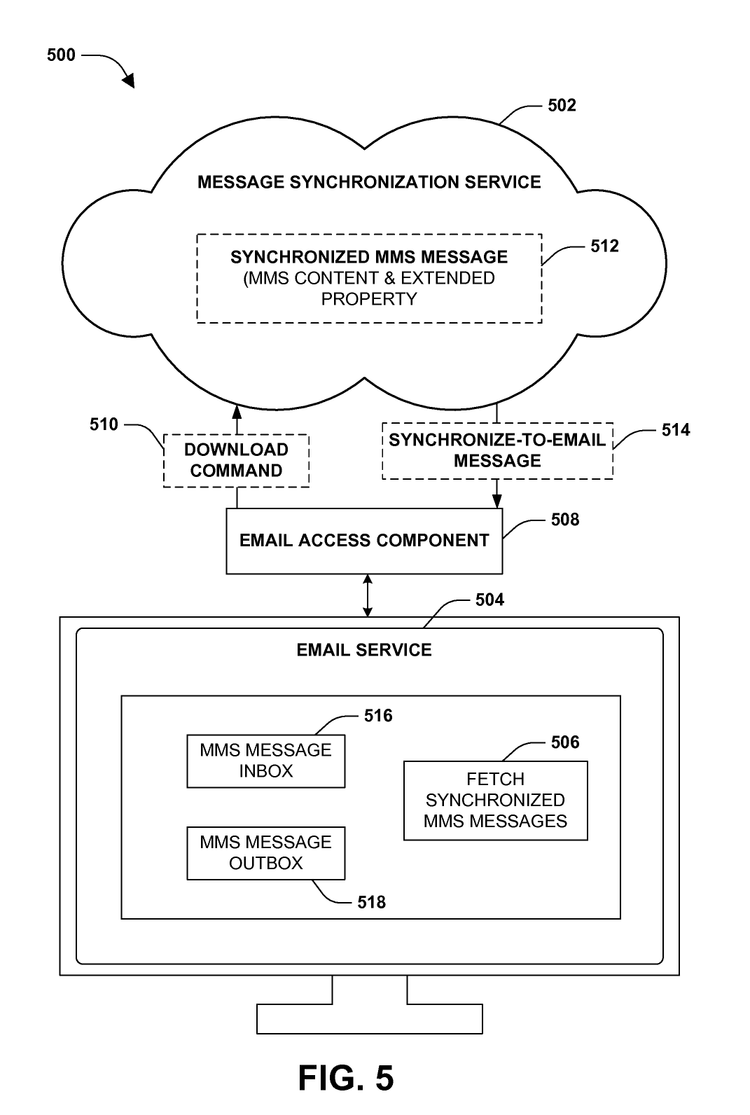

The upload component 306 may be configured to send the synchronize-to-service message 310 to the message synchronization service 302. In one example, the upload component 306 may utilize a MIME message and/or a body, such as body text, comprising at least one attachment. In this way, the message synchronization service 302 may utilize the synchronize-to-service message 310 to store the MMS message as a synchronized MMS message 312 comprising the MMS content and the extended property. The synchronized MMS message 312 may be available for download by the first computing device 304, a different computing device (e.g., FIG. 4), and/or an email service (e.g., FIG. 5).

FIG. 4 illustrates an example of a system 400 configured for synchronizing a text message, such as an SMS message and/or an MMS message, between a computing device and a message synchronization service 402. It may be appreciated that while system 400 is described with relation to an MMS message, that system 400 may also apply to an SMS message. The system 400 may comprise a download component 406. For example, the download component 406 may be hosted by a second computing device 404. In one example the second computing device 404 may be a different computing device than a first computing device, such as the first computing device 304 of FIG. 3, for example, used to upload the MMS message (e.g., a user may have upgraded from the first computing device 304 to the second computing device 404, and may desire to download MMS messages that were synchronized from the first computing device 304 to the message synchronization service 402). Accordingly, the download component 406 may request a synchronized MMS message 410 by sending a download command 408 to the message synchronization service 402.

The download component 406 may receive a synchronize-to-device message 412. The synchronize-to-device message 412 may comprise MMS content and/or an extended property of the synchronized MMS message 410. For example, the extended property may be stored within an annotation, a schema header, and/or an extended header within the synchronize-to-device message 412. The download component 406 may use the synchronize-to-device message 412 to create a restored MSS message comprising the MMS content and/or the extended property. In this way, the synchronized MMS message 410 may be downloaded to various computing devices in full fidelity.

FIG. 5 illustrates an example of a system 500 configured for synchronizing a text message, such as an SMS message and/or an MMS message, between an email service 504 and a message synchronization service 502. It may be appreciated that while system 500 is described with relation to an MMS message, that system 500 may also apply to an SMS message. The system 500 may comprise an email access component 508 associated with the email service 504, such as an online email application and/or a local email application. The email access component 508 may be configured to provide access, through the email service 504, to a synchronized MMS message 512 maintained by the message synchronization service 502. In one example, the synchronized MMS message 512 may correspond to an original MMS message that was uploaded to the message synchronization service 502. Because the original MMS message may have been uploaded in full fidelity, synchronized MMS message 512 may comprise one or more extended properties of the original MMS.

The email access component 508 may be configured to send a download command 510 to the message synchronization service 502. For example, the email access component 508 may send the download command 510 in response to a user invoking a fetch synchronized MSS messages button 506 within the email service 504. Responsive to receiving the download command 510, the message synchronization service 502 may create a synchronize-to-email message 514 comprising MMS content and/or the one or more extended properties. In one example, the one or more extended properties may be stored within one or more annotations, a schema header, and/or within an extended header within the synchronize-to-email message 514. The email access component 508 may receive the synchronize-to-email message 514 from the message synchronization service 502. In this way, the email access component 508 may provide access to the synchronized MMS message 512 using the synchronize-to-email message 514. In one example, if an extended property of the synchronized MMS message 512 indicates that the original MMS message was received as an in-bound message, then the email access component 508 may provide access to the synchronized MMS message 512 through an MMS message inbox 516. In another example, if an extended property of the synchronized MMS message 512 indicates that the original MSS message was sent as an out-bound message, then the email access component 508 may provide access to the synchronized MMS message 512 through an MMS message outbox 518, for example. In another example, the synchronized MMS message 512 is provided through a Sent Items folder (not illustrated).

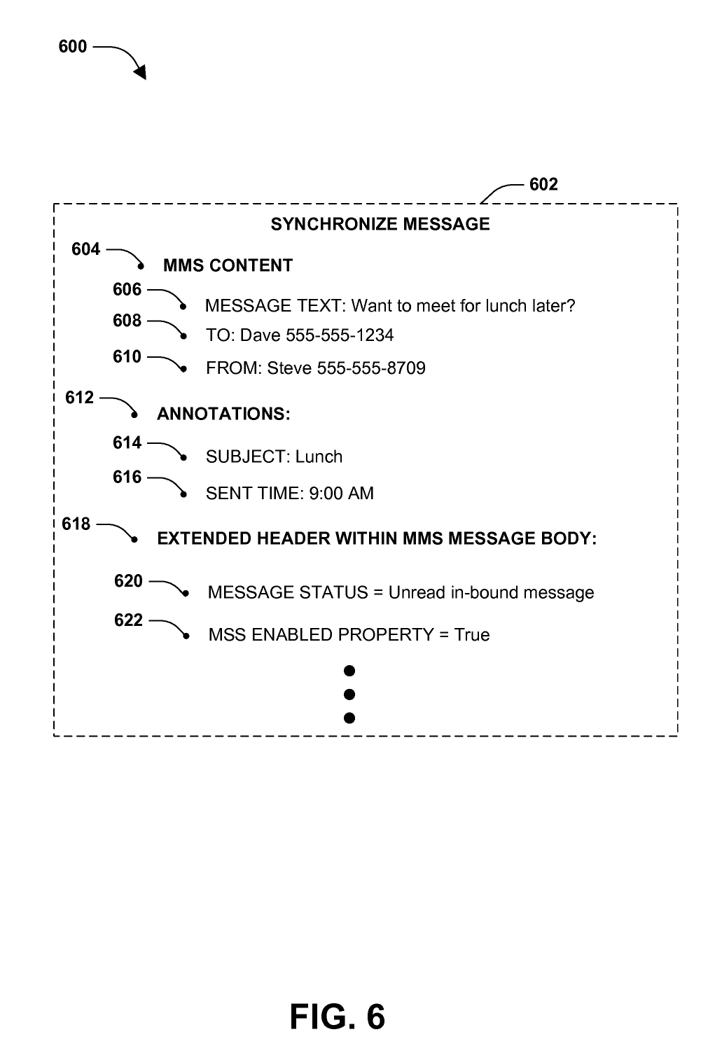

FIG. 6 illustrates an example 600 of a synchronize message 602. It may be appreciated that while example 500 is described with relation to an MMS message, that example 500 may also apply to an SMS message. The synchronize message 602 may correspond to a synchronize-to-service message, a synchronize-to-device message, a synchronize-to-email message, and/or other messages relating to synchronizing text messages, such as SMS and/or MMS messages, for example.

The synchronize message 602 may comprise MMS content 604 associated with an MMS message. In one example of the MMS message, the MMS message comprises a text message comprising multimedia content, such as an image and/or audio, for example. In another example of the MSS message, the MMS message comprises a text message addressed to multiple recipients (e.g., with or without additional multimedia content). For example, the MMS content 604 may comprise message text 606 “want to meet for lunch later?”, a “to” property 608 “Dave 555-555-1234”, and/or a “from” property 610 “Steve 555-555-8709”. In one example, the MMS content 604 of the MMS message may be transmitted through the synchronize message 602 by a message synchronization protocol modified to support MMS messages, for example.

The MMS message may comprise one or more extended properties, such as a subject property 614 “lunch”, a sending time property 616 “9:00 AM”, a message status property 620 “Unread in-bound message”, an MMS enabled property 622 “true”, and/or other extended properties not illustrated. Unfortunately, conventional message synchronization protocols may not natively support such extended properties. Thus, synchronization of the MMS message by a conventional message synchronization protocol may not synchronize the one or more extended properties. For example, a resulting synchronized MMS message may comprise the MMS content 604, but may not comprise the extended properties 614, 616, 620, and/or 622.

Accordingly, the message synchronization protocol may be modified to support annotations 612 and/or an extended header 618 within which the one or more extended properties may be defined. For example, the subject property 614 and/or the sending time property 616 may be specified as annotation 612, such as according to an XML annotation format. The message status property 620 and/or the MSS enabled property 622 may be specified within an extended header within an MMS message body. In this way, a resulting synchronized MMS message may comprise the MMS content 604 and the extended properties 614, 616, 620, and/or 622.

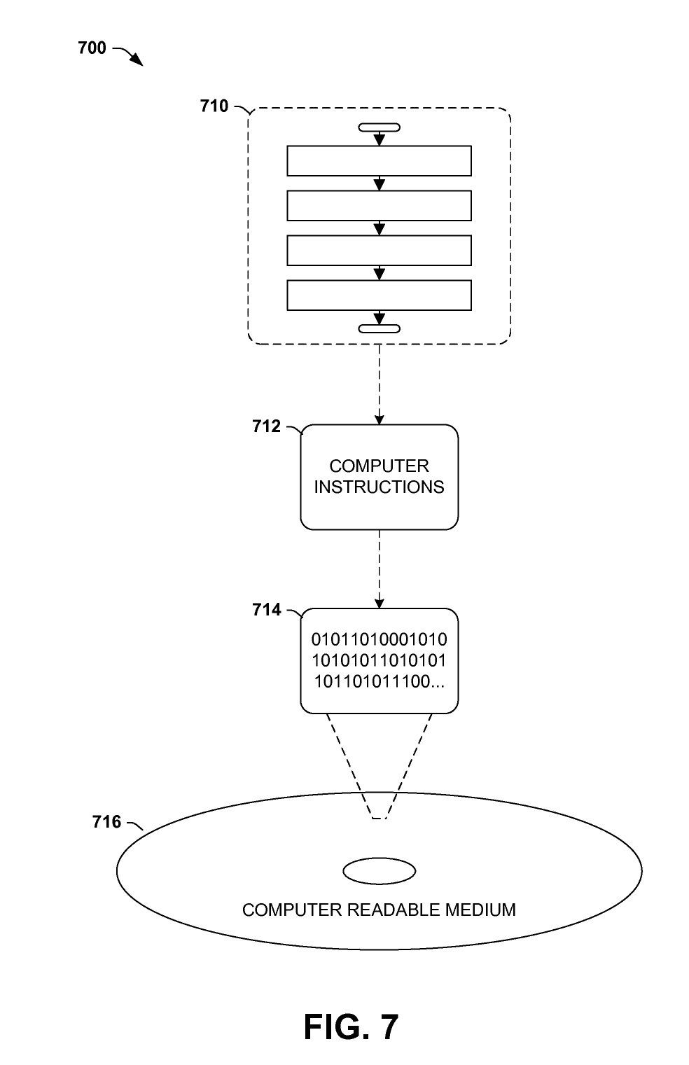

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 716 (e.g., a CD-R, DVD-R, or a platter of a hard disk drive), on which is encoded computer-readable data 714. This computer-readable data 714 in turn comprises a set of computer instructions 712 configured to operate according to one or more of the principles set forth herein. In one such embodiment 700, the processor-executable computer instructions 712 may be configured to perform a method 710, such as at least some of the exemplary method 100 of FIG. 1 and/or at least some of exemplary method 200 of FIG. 2, for example. In another such embodiment, the processor-executable instructions 712 may be configured to implement a system, such as at least some of the exemplary system 300 of FIG. 3, at least some of the exemplary system 400 of FIG. 4, and/or at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

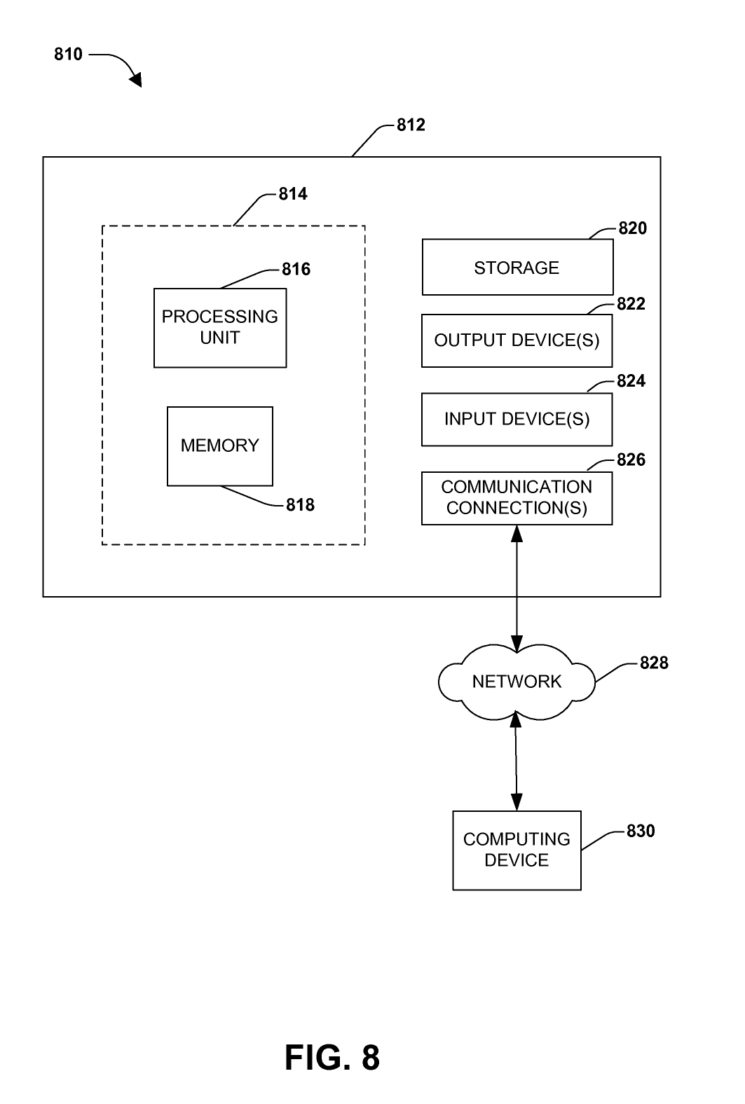

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A method for synchronizing a short message service (SMS) message between a computing device and a message synchronization service, comprising:
generating a synchronize-to-service message associated with an SMS message, wherein the SMS message comprises SMS content and an extended property, the generating comprising:
storing the SMS content in the synchronize-to-service message; and
storing the extended property of the SMS message within at least one of an annotation or an extended header within the synchronize-to-service message; and
sending the synchronize-to-service message to a message synchronization service for storage of the SMS message as a synchronized SMS message comprising the extended property, wherein the synchronize-to-service message synchronizes the SMS message to a synchronization service in full fidelity.

2. The method of claim 1, comprising:
receiving a synchronize-to-device message from the message synchronization service, the synchronize-to-device message comprising:
the SMS content associated with the synchronized SMS message stored by the message synchronization service; and
the extended property of the synchronized SMS message stored within at least one of an annotation or an extended header within the synchronize-to-device message; and
restoring the synchronized SMS message for use by a local SMS messaging application as a restored SMS message, the restored SMS message comprising the extended property.

3. The method of claim 1, the storing the extended property comprising:
storing the extended property as the extended header within an SMS message body; and
storing the SMS message body within the synchronize-to-service message.

4. The method of claim 1, the annotation defined according to an XML annotation format of a message synchronization protocol utilized by the message synchronization service.

5. The method of claim 1, the extended property comprising at least one of a delivery property, a sent property, a subject property, or a message status property.

6. The method of claim 1, comprising:
obtaining access, through an email service, to the synchronized SMS message maintained by the message synchronization service.

7. A method for synchronizing a text message between a computing device and a message synchronization service, comprising:
receiving, at a message synchronization service, a synchronize-to-service message from a computing device, the synchronize-to-service message comprising text message content associated with a text message and an extended property stored within at least one of an annotation or an extended header within the synchronize-to-service message; and
creating a synchronized text message based upon the synchronize-to-service message, the synchronized text message comprising the extended property, wherein the synchronize-to-service message synchronizes the text message to a synchronization service in full fidelity.

8. The method of claim 7, comprising:
responsive to receiving a download command from the computing device for the synchronized text message, creating a synchronize-to-device message comprising the text message content and the extended property associated with the synchronized text message, the extended property stored within at least one of a second annotation or a second extended header within the synchronize-to-device message; and
sending the synchronize-to-device message to the computing device for restoration of the synchronized text message as a restored text message comprising the extended property.

9. The method of claim 7, comprising:
responsive to receiving a download command from a second computing device different than the computing device, creating a synchronize-to-device message comprising the text message content and the extended property associated with the synchronized text message, the extended property stored within at least one of a second annotation or a second extended header within the synchronize-to-device message; and
sending the synchronize-to-device message to the second computing device.

10. The method of claim 7, comprising:
responsive to receiving a download command from an email service, creating a synchronize-to-email service message comprising the text message content and the extended property associated with the synchronized text message, the extended property stored within at least one of a second annotation or a second extended header within the synchronize-to-email message; and
sending the synchronize-to-email service message to the email service for facilitating user access to the synchronized text message through the email service.

11. The method of claim 10, the synchronized text message displayed within an email message box of an email application hosted by the email service.

12. The method of claim 7, the extended property indicating that the text message comprises a multimedia message service (MMS) message.

13. The method of claim 7, utilizing, by the message synchronization service, a message synchronization protocol modified to support at least one of uploading, downloading, or synchronizing of MMS messages.

14. A system for synchronizing a multimedia message service (MMS) message between a computing device and a message synchronization service, comprising:
an upload component configured to:
generate a synchronize-to-service message associated with an MMS message, wherein the MMS message comprises MMS content, comprising:
storing the MMS content in the synchronize-to-service message; and
storing an extended property of the MMS message within at least one of an annotation, a schema header, or an extended header within the synchronize-to-service message; and
send the synchronize-to-service message to a message synchronization service for storage of the MMS message as a synchronized MMS message comprising the extended property, wherein the synchronize-to-service message synchronizes the MMS message to a synchronization service in full fidelity.

15. The system of claim 14, the upload component configured to:
utilize a message synchronization protocol modified to support at least one of uploading, downloading, or synchronizing of MMS messages.

16. The system of claim 15, comprising:
a download component configured to:
receive a synchronize-to-device message from the message synchronization service, the synchronize-to-device message comprising:
MMS content associated with the synchronized MMS message stored by the message synchronization service; and
the extended property of the synchronized MMS message stored within at least one of an annotation, a schema header, or an extended header within the synchronize-to-device message; and
restore the second synchronized MMS message for use by a local MMS messaging application as a restored MMS message, the restored MMS message comprising the extended property.

17. The system of claim 16, at least one of the upload component or the download component configured to utilize an Exchange ActiveSync protocol modified to support one or more extended properties based upon at least one of an MMS message class or an MMS message type.

18. The system of claim 15, comprising:
an email access component configured to:
provide access, through an email service, to the synchronized MMS message maintained by the message synchronization service.

19. The system of claim 15, the upload component configured to:
upload the MMS content as at least one of a MIME message or a body comprising at least one attachment.

20. The system of claim 16, at least one of the upload component or the download component configured to utilize an Exchange ActiveSync protocol modified to support one or more extended properties defined within at least one of an annotation, a schema header or an extended header within an MMS message body.
